(19) United States
(12) Patent Application Publication
(10) Pub. No.: US 2024/0222101 A1
(43) Pub. Date: Jul. 4, 2024

(54) AMPLIFICATION AND DETECTION OF COMPOUND SIGNALS

(71) Applicant: Donald Danforth Plant Science Center, St. Louis, MO (US)

(72) Inventors: Allen Hubbard, St. Louis, MO (US); Shrikaar Kambhampati, St. Louis, MO (US); Brad Evans, St. Louis, MO (US)

(21) Appl. No.: 18/577,578

(22) PCT Filed: May 6, 2022
(86) PCT No.: PCT/US22/28150

§ 371 Date: Jan. 8, 2024

Related U.S. Application Data
(60) Provisional application No. 63/185,674, filed on May 7, 2021.

(51) Int. Cl. H01J 49/00

(52) U.S. Cl. CPC H01J 49/0036

(57) ABSTRACT

Systems and methods for amplification and detection of metabolite signals are provided. A plurality of files containing m/z signal intensities may be captured by a mass spectrometer. Each file of m/z signal intensities may include signals associated with mass measurements of compounds in a respective sample. The datasets of the chromatograms may be combined into a merged spectra of m/z signal intensities. A concentration of signals may be identified in the merged chromatogram as following a specified statistical distribution and determined to be indicative of a metabolite when the concentration of signals corresponds to one or more mass measurements associated with a metabolite and an isotopologue of the metabolite.

### CROSS-REFERENCE TO RELATED APPLICATIONS

This application claims priority from Provisional Application No. 63/185,674, filed May 7, 2021, the entire contents of which are hereby incorporated by reference.

### GOVERNMENTAL RIGHTS

This invention was made with government support under DE-SC-18277 awarded by the Department of Energy. The government has certain rights in the invention.

### BACKGROUND OF THE INVENTION

### 1. Field of the Invention

The present disclosure relates generally to compound detection. More specifically, the present disclosure relates to amplification and detection of compound signals.

### 2. Description of the Related Art

Liquid chromatography-mass spectrometry (LC-MS) is a chemical technique that relies on two dimensions of separation to identify different compounds in a sample as unique mass features. A liquid chromatography system may separate the different compounds by structural properties, while a mass spectrometer subsequently determines the mass and intensity of the ions that elute from the chromatography column. Modern high-resolution mass spectrometry can now detect and quantify ions with high mass precision (<5 ppm mass error), but may also result in significant amounts of noise.

Thus, detecting valid compound peaks within mass spectrometry data may therefore present a number of challenges when the compound may only be present at low levels relative to noise. For example, samples from complex systems may include large numbers of different compounds, some of which (e.g., metabolites) may only be present in relatively low quantities. A typical mass spectrometry file may contain as many as millions of data points, while as few as several hundred to thousands may correspond to true metabolite signals that are interspersed in vast amounts of noise. Such metabolite signals are generally analyzed computationally, but existing computational methods are often incapable of detecting or identifying many metabolite signals amidst the noise. While some methods may use pre-filtering in an attempt to filter out noise, such methods end up discarding valid metabolite signals.

The challenge of distinguishing signal from noise is further exacerbated by the inability of existing approaches to deal with the totality of a dataset simultaneously. Some current solutions rely on processing small, limited slices of a dataset in increments. Due to such limitations, not only do existing approaches fail to identify metabolite signals present in a mass spectrometry file, but such approaches may also frequently make the converse mistake of misidentifying noise signals as representing potential metabolites. Thus, such solutions may be prone to false positives, dropouts, and mismatched noise and signal.

Other attempts to get around such computational limitations so as to accurately identify metabolites in an untargeted fashion have had serious drawbacks. For example, one particular method of validating true metabolite signals requires repeated collection and labelling of samples multiple times (e.g., prior to exposure and saturation point after exposure), which can be laborious and time-consuming. Presently available labelling methods may not be equally applicable, effective, or practical, however, with the varied components that may be present in complex systems (e.g., organisms that cannot be cultured or labelled). Thus, the applicability and effectiveness of such label-based methods may be limited to simple systems. Further, such label-based methods are incapable of scaling for use in detecting, identifying, and quantifying metabolites in an untargeted fashion in increasingly larger and more complicated datasets.

Thus, there is a need for improved systems and methods of identifying metabolite signals accurately from datasets of hundreds to thousands of samples in any species within a totality of an untargeted LC-MS dataset.

### SUMMARY OF THE INVENTION

One aspect of the present disclosure encompasses a method for amplification and detection of compound signals. The method comprises the following steps: (a) receiving a plurality of data files that include mass-to-charge (m/z) signal intensities captured by a mass spectrometer, wherein the m/z signal intensities correspond to signals associated with mass measurements of compounds in a sample; (b) combining the plurality of data files into a merged file that includes a merged spectra of m/z signal intensities; (c) identifying a concentration of signals within the merged spectra of m/z signal intensities of the merged file, the concentration of signals identified as following a specified statistical distribution; and (d) determining that the concentration of signals is indicative of a compound when the concentration of signals corresponds to one or more mass measurements associated with the compound and an isotopologue of the compound.

In some aspects, the concentration of signals within the merged m/z signal intensities is indicative of the compound includes verifying that the concentration of signals includes a first peak associated with the compound and a second peak associated with the isotopologue. The first peak can be offset from the second peak based on a difference in mass between the compound and the isotopologue, and verifying the concentration of signals can include initially identifying the first peak and subsequently identifying the second peak based on the offset.

The method can further comprise identifying the type of the compound based on the mass measurements, wherein the type of the compound is identified as at least one of a specific metabolite or organic compound. The isotopologue includes a carbon-13 isotope of the compound, and the concentration of signals includes a first peak associated with the compound that is offset from a second peak associated with the isotopologue, the offset corresponding to carbon-13 mass.

In some aspects, the specified statistical distribution follows a Gaussian distribution. When the specified statistical distribution follows a Gaussian distribution, the method can further comprise correcting for drift among the plurality of data files based on a mass offset associated with the compound and the isotopologue. Further, correcting for drift can comprise generating a mass-shifted m/z signal intensities file by injecting a mass shift to each of the signals in the merged spectra of m/z signal intensities; and updating the merged file of m/z signal intensities based on the generated mass-shifted m/z signal intensities file. In some aspects, correcting for drift further comprises identifying an optimal amount of the mass shift based on the mass offset associated with the compound and the isotopologue. Identifying the amount of mass shift can comprise comparing a peak associated with the compound and a peak associated with the isotopologue in at least two samples; identifying pairs of the compound and the isotopologue based on the mass offset, wherein each of the pairs is associated with an amount of mass shift; and identifying the optimal amount of mass shift based on correspondence to a greatest number of pairs.

Another aspect of the present disclosure encompasses a system for amplification and detection of compound signals. The system comprises an interface that receives a plurality of data files that include mass-to-charge (m/z) signal intensities captured by a mass spectrometer, wherein the m/z signal intensities correspond to signals associated with mass measurements of compounds in a sample; and a processor that executes instructions stored in memory. The processor executes the instructions to combine the plurality of data files into a merged file that includes a merged spectra of m/z signal intensities; identify a concentration of signals within the merged spectra of m/z signal intensities of the merged file, the concentration of signals identified as following a specified statistical distribution; and determine that the concentration of signals is indicative of a compound when the concentration of signals corresponds to one or more mass measurements associated with the compound and an isotopologue of the compound.

In some aspects, the processor determines that the concentration of signals within the merged m/z signal intensities is indicative of the compound by verifying that the concentration of signals includes a first peak associated with the compound and a second peak associated with the isotopologue. The first peak can be offset from the second peak based on a difference in mass between the compound and the isotopologue, and wherein the processor verifies the concentration of signals by initially identifying the first peak and subsequently identifying the second peak based on the offset.

In some aspects, the processor executes further instructions to identify the type of the compound based on the mass measurements, wherein the type of the compound is identified as at least one of a specific metabolite or organic compound. In some aspects, the isotopologue includes a carbon-13 isotope of the compound, and wherein the concentration of signals includes a first peak associated with the compound that is offset from a second peak associated with the isotopologue, the offset corresponding to carbon-13 mass. The specified statistical distribution can follow a Gaussian distribution. the specified statistical distribution follows a Gaussian distribution.

The processor can execute further instructions to correcting for drift among the plurality of data files based on a mass offset associated with the compound and the isotopologue. For instance, the processor can correct for drift by generating a mass-shifted m/z signal intensities file by injecting a mass shift to each of the signals in the merged spectra of m/z signal intensities; and updating the merged file of m/z signal intensities based on the generated mass-shifted m/z signal intensities file. In some aspects, the processor executes further instructions to identify an optimal amount of the mass shift based on the mass offset associated with the compound and the isotopologue. The processor can identify the amount of mass shift by comparing a peak associated with the compound and a peak associated with the isotopologue in at least two samples; identifying pairs of the compound and the isotopologue based on the mass offset, wherein each of the pairs is associated with an amount of mass shift; and identifying the optimal amount of mass shift based on correspondence to a greatest number of pairs.

An additional aspect of the present disclosure encompasses a non-transitory computer-readable storage medium having embodied thereon instructions executable by a processor to perform a method for amplification and detection of compound signals. The method comprises the steps of: (a) receiving a plurality of data files that include mass-to-charge (m/z) signal intensities captured by a mass spectrometer, wherein the m/z signal intensities correspond to signals associated with mass measurements of compounds in a sample; (b) combining the plurality of data files into a merged file that includes a merged spectra of m/z signal intensities; (c) identifying a concentration of signals within the merged spectra of m/z signal intensities of the merged file, the concentration of signals identified as following a specified statistical distribution; and (d) determining that the concentration of signals is indicative of a compound when the concentration of signals corresponds to one or more mass measurements associated with the compound and an isotopologue of the compound.

In some aspects, determining that the concentration of signals within the merged m/z signal intensities are indicative of the compound includes verifying that the concentration of signals includes a first peak associated with the compound and a second peak associated with the isotopologue. The first peak can be offset from the second peak based on a difference in mass between the compound and the isotopologue, and verifying the concentration of signals can include initially identifying the first peak and subsequently identifying the second peak based on the offset.

In some aspects, the non-transitory computer-readable storage medium further comprises instructions executable to identify the type of the compound based on the mass measurements, wherein the type of the compound is identified as at least one of a specific metabolite or organic compound.

In some aspects, the isotopologue includes a carbon-13 isotope of the compound, and wherein the concentration of signals includes a first peak associated with the compound that is offset from a second peak associated with the isotopologue, the offset corresponding to carbon-13 mass. The specified statistical distribution can follow a Gaussian distribution.

The non-transitory computer-readable storage medium can further comprise instructions executable to correct for drift among the plurality of data files based on a mass offset associated with the compound and the isotopologue. In some aspects, identifying the amount of mass shift comprises comparing a peak associated with the compound and a peak associated with the isotopologue in at least two samples; identifying pairs of the compound and the isotopologue based on the mass offset, wherein each of the pairs is associated with an amount of mass shift; and identifying the optimal amount of mass shift based on correspondence to a greatest number of pairs.

### BRIEF DESCRIPTION OF THE DRAWINGS

The patent or application file contains at least one drawing originally executed in color. Copies of this patent or patent application publication with color drawing(s) will be provided by the Office upon request and payment of the necessary fee.

FIG. 1A illustrates an exemplary mass spectrometry dataset of a small size and related distributions associated with certain compounds.

FIG. 1B illustrates an exemplary mass spectrometry dataset of an intermediate size and related distributions associated with certain compounds.

FIG. 1C illustrates an exemplary mass spectrometry dataset of a large size and distributions associated with certain compounds.

FIG. 2A illustrates an exemplary mass spectrometry dataset for citrulline.

FIG. 2B illustrates an exemplary mass spectrometry dataset for a citrulline isotopologue.

FIG. 2C illustrates a set of exemplary mass spectrometry datasets for citrulline illustrating signal amplification as sample number increases in a merged file of m/z signal intensities.

FIG. 2D illustrates a set of exemplary mass spectrometry datasets for a citrulline isotopologue illustrating signal amplification as sample number increases in a merged file of m/z signal intensities.

FIG. 2E illustrates an alternative set of exemplary mass spectrometry datasets for citrulline illustrating signal amplification as sample number increases in a merged file of m/z signal intensities.

FIG. 2F illustrates an alternative set of exemplary mass spectrometry datasets for a citrulline isotopologue illustrating signal amplification as sample number increases in a merged file of m/z signal intensities.

FIG. 3A illustrates an exemplary metabolite signal associated with an isotopologue signal.

FIG. 3B illustrates an exemplary metabolite signal associated with two isotopologue signals.

FIG. 4A illustrates an exemplary set of merged m/z signal intensities resulting from the combination of a plurality of files containing m/z signal intensities from individual samples within multiple sample batches where there is a 2 ppm mass shift between the two batches, which impacts the m/z signal intensity for both the compound and its isotopologue.

FIG. 4B illustrates that different mass shifts that are less than the actual mass shift generate varying numbers of isopairs depending on the distance from the true mass shift, where a putative mass shift that is less than the actual mass shift may generate fewer isopairs than the true mass shift of 2 ppm and the true mass shift of 2 ppm may produce the most isopairs.

FIG. 4C illustrates that different mass shifts greater than the actual mass shift generate varying numbers of isopairs, depending on the distance from the true mass shift where a putative mass shift that is more than the actual mass shift may generate fewer isopairs than the true mass shift of 2 ppm and the true mass shift of 2 ppm may produce the most isopairs.

FIG. 4D illustrates a merged spectra of m/z signal intensities in which the mass drift has been corrected via a shift of 2 ppm, thereby maximizing the ability to detect isopairs.

FIG. 4E illustrates merged spectra of m/z signal intensities before and after the mass drift of citrulline has been corrected via a shift of 2 ppm based on the true mass shift determined in FIG. 4D.

FIG. 5 is a flowchart illustrating an exemplary method for amplification and detection of metabolite signals.

FIG. 6 shows an example of a system for implementing certain aspects of the present technology.

### DETAILED DESCRIPTION

Embodiments of the present disclosure include systems and methods for amplification and detection of compound signals. A plurality of m/z signal intensities may be captured by a mass spectrometer in an output file. Mass-to-charge ratio (m/z) data describes the mass to charge ratio of an ion deriving from a measurable compound, while intensity data records the abundance of a species of a given m/z. Each output file may include signals associated with mass measurements of compounds in a respective sample, as well as retention time information that may be represented in a chromatogram. The datasets of the output files may be combined into a merged file of m/z signal intensities. A concentration of signals may be identified in the merged m/z signal-intensities following a specified statistical distribution and determined to be indicative of a compound of specific m/z when the concentration of signals corresponds to one or more mass measurements associated with the compound and an isotopologue of the compound. Isotopologues are structurally and chemically identical to the compound, except for the mass difference of a specific isotope atom. Thus, the difference in mass between the compound and its corresponding isotopologue is based on the mass of the specific isotope atom.

In some embodiments, liquid chromatography-mass spectrometry (LC-MS) can be used for untargeted analyses of chemical, biochemical, and metabolomic compounds. While specific types of compounds (e.g., metabolites, citrulline) may be discussed herein, such discussion of specific embodiments is for illustrative purposes and should not be interpreted as limiting the present disclosure to the specific embodiments being illustrated and discussed. In order to harness the sensitivity of LC-MS while avoiding associated noise, embodiments of the present disclosure separate true and valid signals indicative of the compound from noise using amplification and validation based on isotopologue analysis. Various embodiments may amplify compound signals by combining or pooling a plurality of m/z signal intensity files together. Such combination may also result in amplification of the associated isotopologue signals.

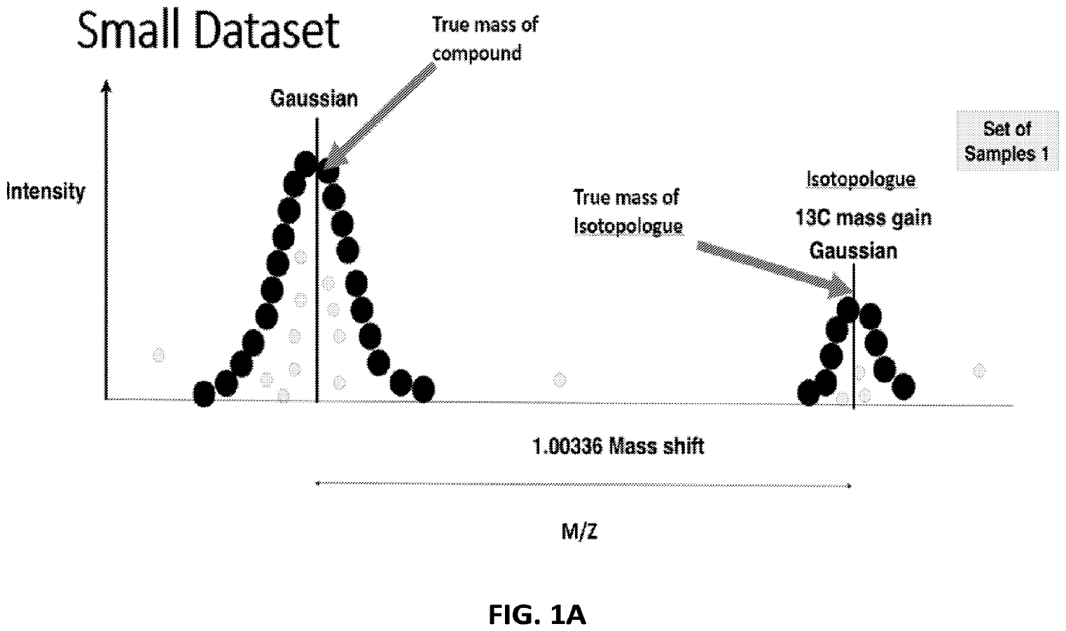

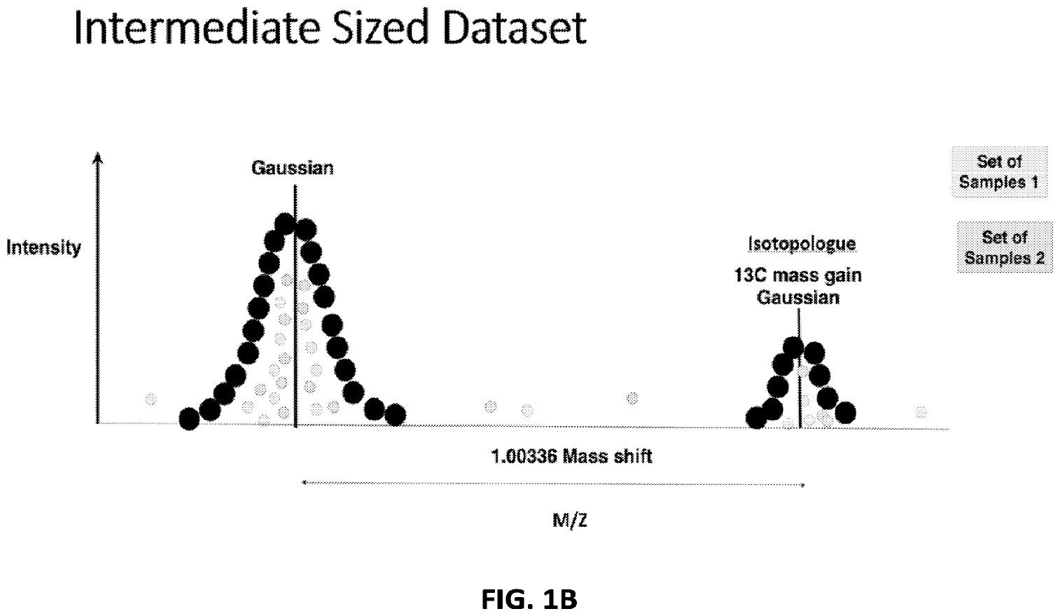

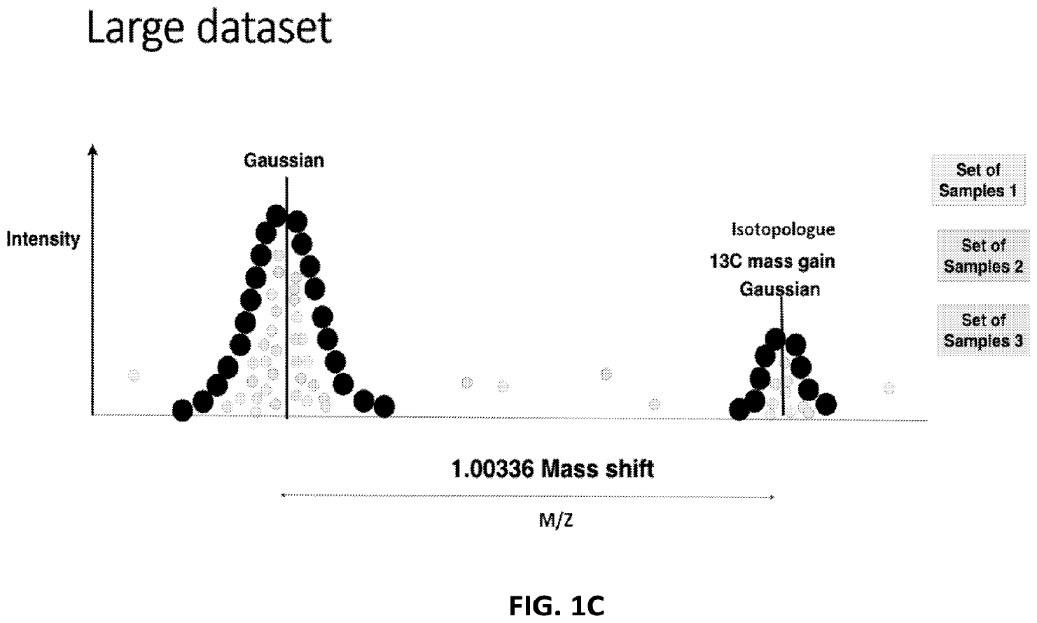

FIGS. 1A-C illustrates exemplary mass spectrometry datasets of different sizes and distributions associated with certain compounds. As illustrated, the differently-sized data sets include different numbers of data points regarding mass spectrometry signals associated with mass measurements of compounds in a sample. While the signals generally fall into a specific distribution (e.g., Gaussian distribution), increasing the number of the data points obtained from plurality of pooled or merged m/z signal intensity files may also increase the prominence and detectability of the specific peak(s) amidst the surrounding noise. Each peak may correspond to a specific mass measurement of a compound, while noise may be more randomly distributed among many millions of detectable compound masses. As a result, when m/z signal intensities from many samples are combined together, the net noise levels may be reduced relative to the compound peaks resulting from aggregation of true and valid signals at a particular mass for the compound. As noise may be randomly distributed in each file of m/z signal intensities, the probability of observing multiple noise signals concentrated at a specific mass may be low to negligible, because the probability of getting noise at the exact m/z (e.g., measured to within 0.0001 of a single Dalton across a range of 1-1000 Daltons) and a high intensity more than once is extremely low in comparison to true and valid signals. Such difference may become even more prominent as the number of samples (and output data files thereof) increase. While the amount of noise signals can increase with more samples, this may be a slow and linear accumulation that may be far outpaced by exponential amplification of valid m/z signals that result from pooling samples into a merged spectra of m/z signal intensities. Importantly, because the production of noise signals may be a random process, the increased statistical power of a merged m/z signal intensities makes it possible to set accurate signal-to-noise thresholds via resampling based on permutation tests minimizes potential false positives. Thus, intensity measurements around signals representing true masses may therefore appear hyper-concentrated in peaks that follow a specific statistical (e.g., Gaussian or Lorentzian) distribution.

FIG. 1A illustrates an exemplary mass spectrometry dataset of a small size and related distributions associated with certain compounds. As illustrated in FIG. 1A, the small dataset (relative to the larger datasets of FIGS. 1B-C) includes a set of signals corresponding to mass measurements associated with a specific compound and an isotopologue of the compound. The set of signals appear, however, in conjunction with a certain amount of noise. While the signals associated with the compound and isotopologue may be consistent with a specific statistical (e.g., Gaussian) distribution, the specific peaks (particularly the peak associated with the isotopologue) may not be concentrated enough to be detectable amidst the noise (which does not follow any particular distribution).

FIG. 1B illustrates an exemplary mass spectrometry dataset of an intermediate size and related distributions associated with certain compounds, and FIG. 1C illustrates an exemplary mass spectrometry dataset of a large size and distributions associated with certain compounds. As illustrated in FIGS. 1B and 1C, increasing the number of data points may concentrate the number of signals within the peaks that follow a Gaussian distribution about the respective mass measurements of the compound and its isotopologue. Thus, combining or aggregating m/z signal intensities from multiple samples may increase the concentration of signals and the prominence of the respective peaks, thereby allowing for more certain detection amidst the noise. In comparison to FIG. 1A, adding more samples may result in more signal intensity measurements representing true masses hyper-concentrating along Gaussian distributions (e.g., within 5 parts per million (ppm)) corresponding to the mass of a specific compound. Thus, the concentration of signals (e.g., in two peaks) may be increased from a signal/noise ratio without requiring signal filtering, which could exclude true compound peaks.

In some embodiments, the compound of interest may be a metabolite or other type of organic compound. An isotopologue of the compound may include, for example, a carbon-13 isotope atom. While such isotopes may naturally occur, such occurrence may be at relatively low levels (e.g., 1% of abundance relative to the associated compound). A true signal for the specific compound may therefore be accompanied by a valid signal of a naturally-occurring isotopologue that is lower in abundance and whose signal is offset from the true signal by exactly the mass difference between the dominant and rarer isotopic species of an element and its (e.g., carbon-13) atom(s). Similar to how aggregated compound signals may hyper-concentrate around the mass of the compound, aggregated isotopologue signals may similarly hyper-concentrate around the mass of the isotopologue. Thus, when m/z-signal intensities from multiple samples are combined into a single, merged file of m/z signal-intensities, the probability of finding a pair of signals offset by the exact mass of one or more carbon-13 atoms (representing a compound and its naturally-occurring isotopologue(s)) at a single retention time window increases significantly. (The chromatogram data can be included in the file of m/z signal intensities if available to ensure that compounds and their isotopologues elute at similar retention times.) An isotopologue can then be detected where the merged file of m/z signal-intensities contains two peaks offset by one or more 13C atoms. Sets of signals linked by a mass shift that is an integer multiple of the mass of a 13C atom may be referred herein as “isopairs.” and may occur at the same retention time as the parent metabolite. The presence of the isotopologue peak may further increase confidence in the determination that the associated compound peak is actually associated with the compound (e.g., rather than noise or any inorganic salts). In addition to organic compounds, the techniques discussed herein may further be applicable to compounds including any other multi-isotopic element, such as nitrogen, oxygen, sulfur, chlorine, bromine, selenium, etc.

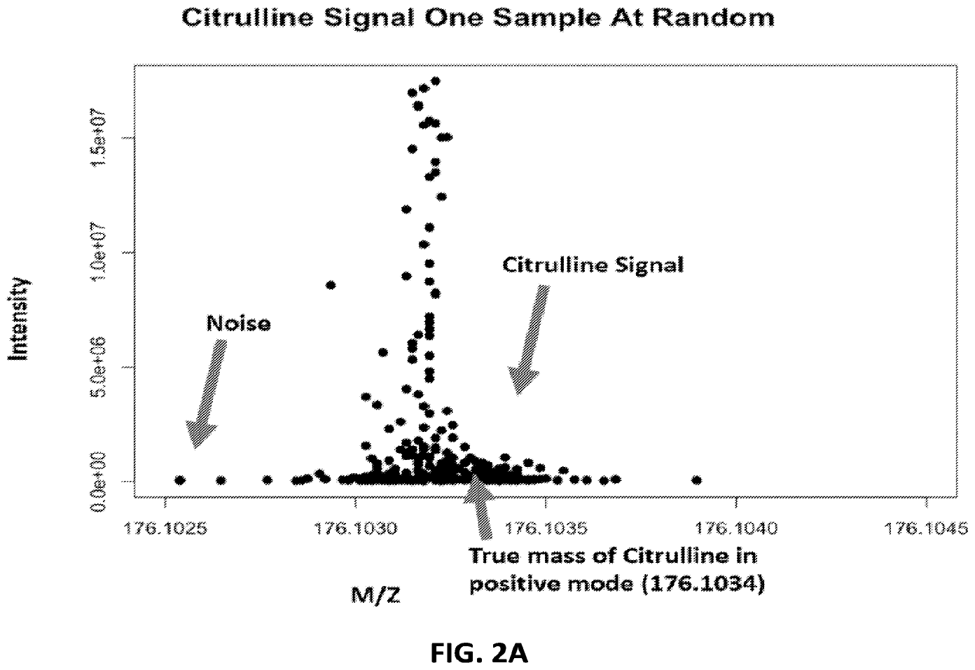

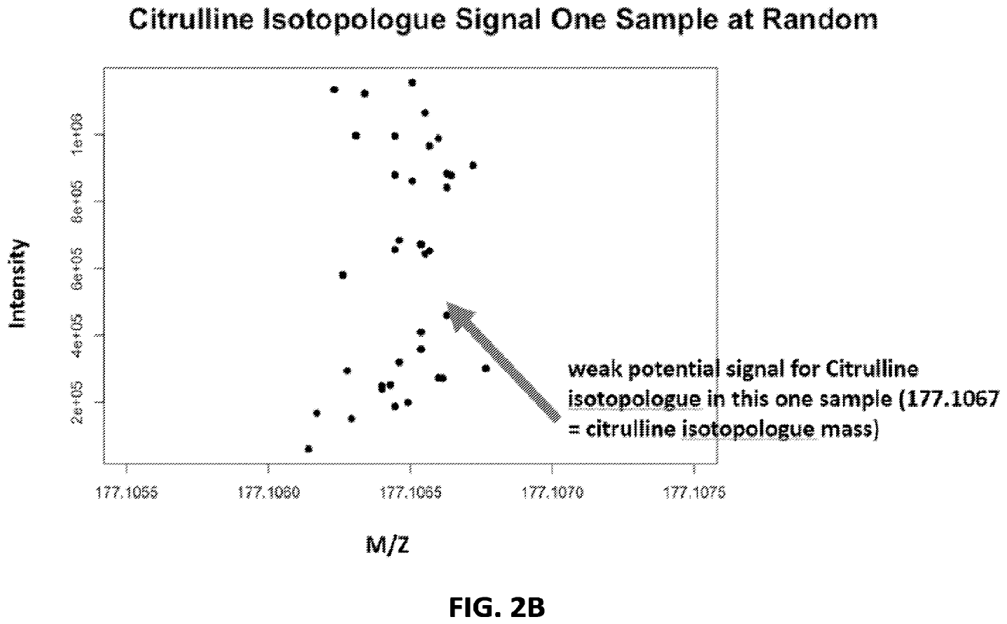

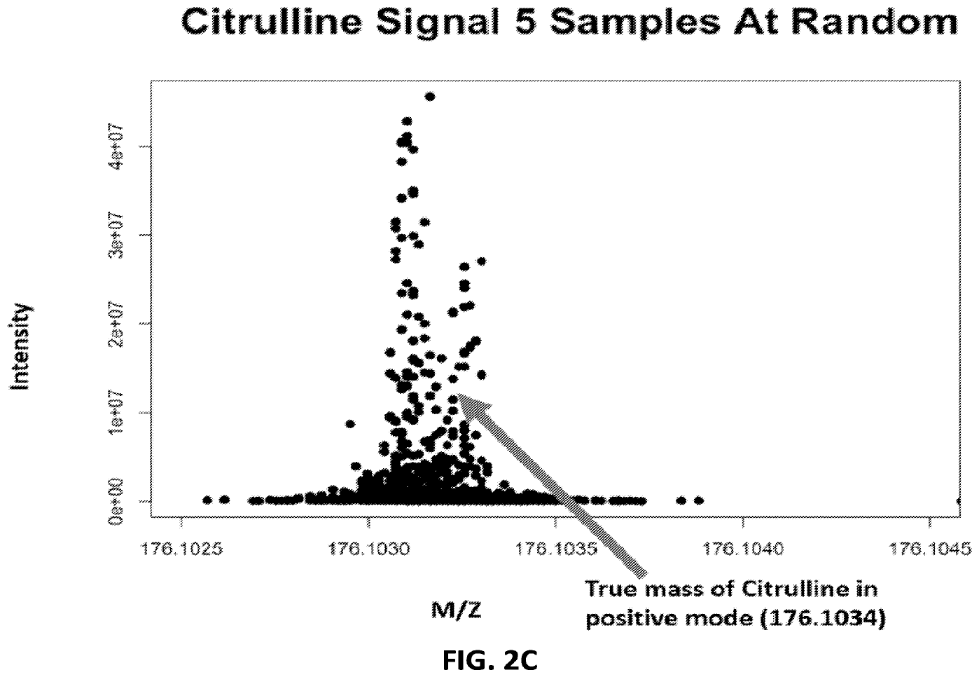

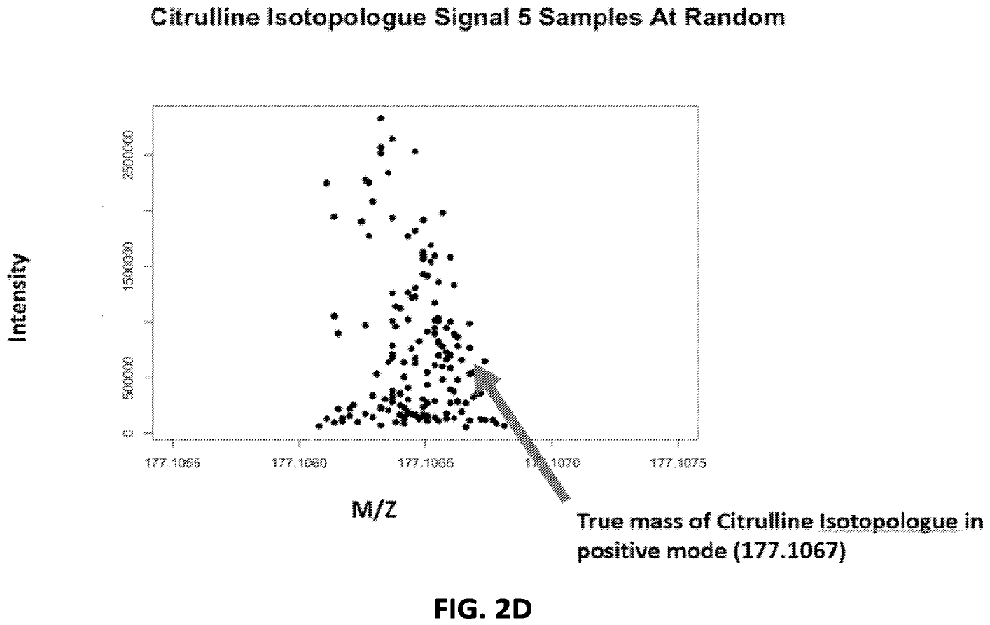

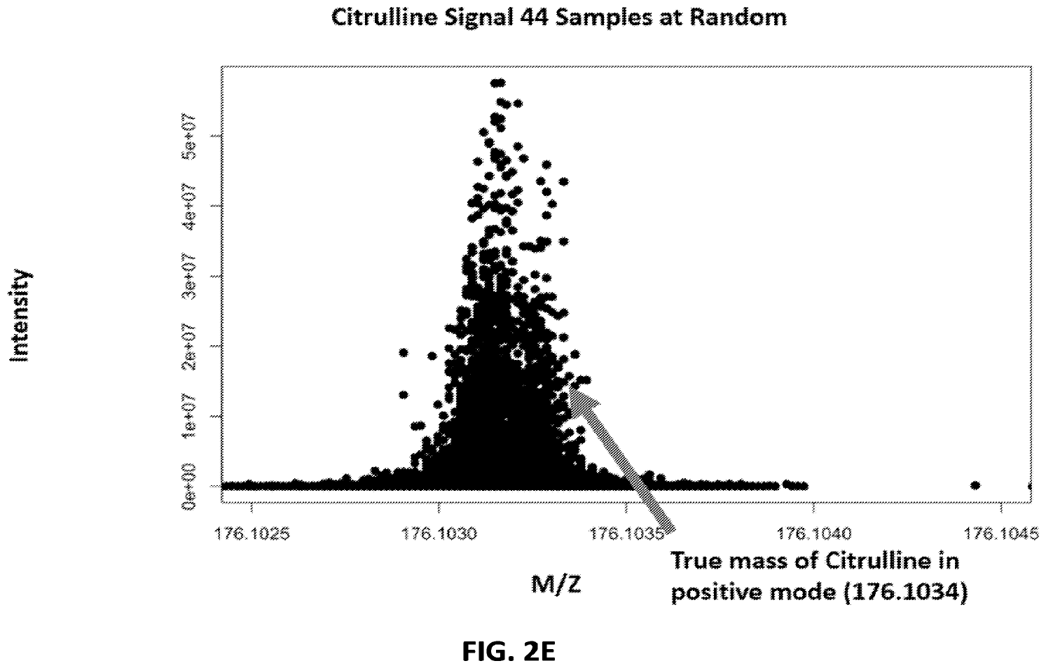

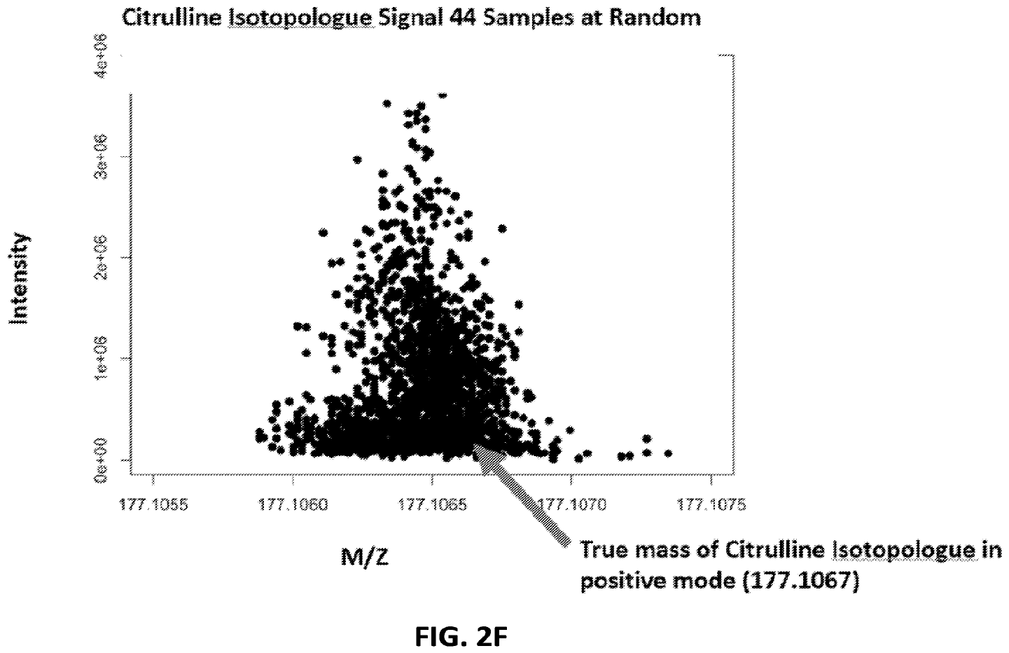

FIGS. 2A-F illustrated exemplary mass spectrometry data for the metabolite compound citrulline and the corresponding naturally-occurring isotopologue of citrulline. In particular, FIGS. 2A-B illustrate a respective mass spectrometry dataset for citrulline and for the citrulline isotopologue, while FIGS. 2C-F illustrated increasingly larger quantities of mass spectrometry datasets for citrulline and the citrulline isotopologue.

In particular, FIG. 2A illustrates an exemplary data set that includes signals clustered at the mass measurement of citrulline (176.1034 under positive mode mass spectrometry) amidst other signals likely associated with noise. The concentration of the signals at citrulline mass measurement may not, however, be readily distinguishable from the noise present in the data set. Meanwhile, as illustrated in FIG. 2B, a single data set may include extremely low levels of the citrulline isotopologue. The concentrations may be further enhanced as the number of data sets is increased. For example, FIGS. 2C-D illustrates that the addition of data sets may concentrate the signals of both citrulline and its isotopologue, while FIGS. 2E-2F illustrate even more concentration as even more data sets are combined. Specifically, FIG. 2C illustrates a set of exemplary mass spectrometry datasets for citrulline illustrating signal amplification as sample number increases in merged files of m/z signal intensities, while FIG. 2D illustrates a set of exemplary mass spectrometry datasets for a citrulline isotopologue illustrating signal amplification as sample number increases in a merged files of m/z signal intensities. Meanwhile, FIG. 2E illustrates an alternative set of exemplary mass spectrometry datasets for citrulline illustrating signal amplification as sample number increases in a merged files of m/z signal intensities, and FIG. 2F illustrates an alternative set of exemplary mass spectrometry datasets for a citrulline isotopologue illustrating signal amplification as sample number increases in a merged files of m/z signal intensities.

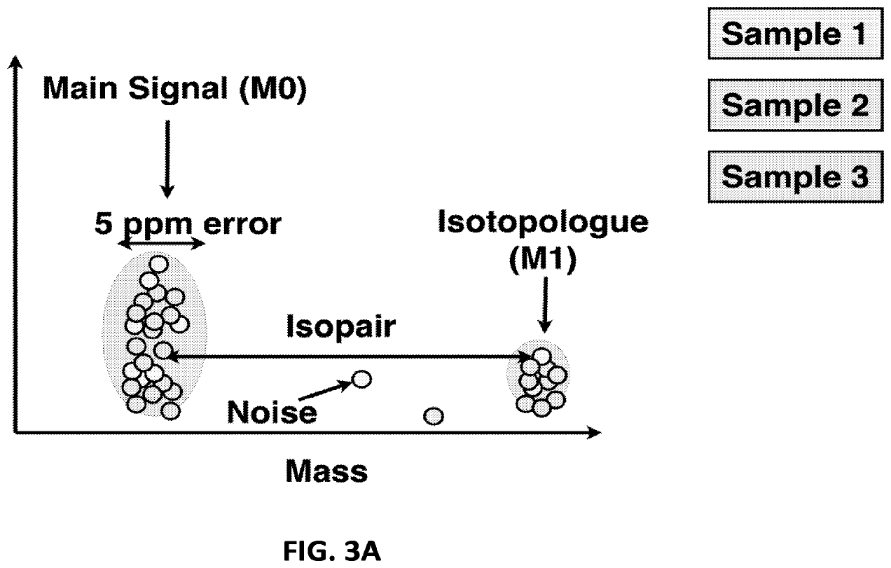

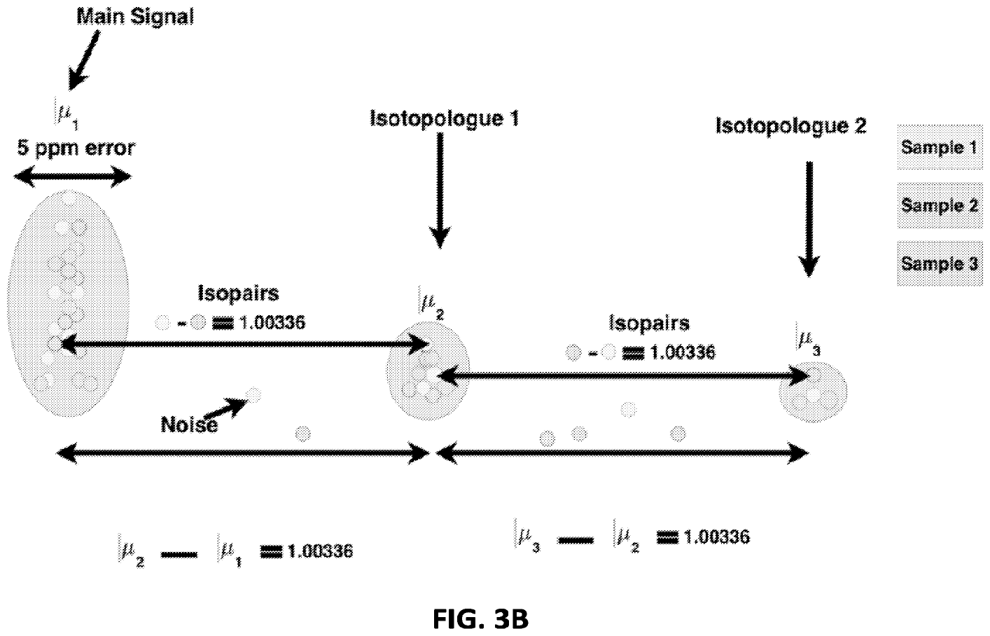

FIG. 3A illustrates an exemplary metabolite signal associated with one isotopologue signals, and FIG. 3B illustrates an exemplary metabolite signal associated with two isotopologue signals. As illustrated, a main signal associated with a specific compound may be associated with an isotopologue signal that is offset by the specific mass of the isotope atom. Pairs associated with the specified offset may be referred to herein as isopairs. In some embodiments, another (secondary) isotopologue signal may be present and offset from the other isotopologue signal by the specific mass of the isotope atom (FIG. 3B). While the isotopologue may be less abundant than the non-isotopic compound, the aggregation of multiple data sets may concentrate the isotopologue signals sufficiently so as to be distinguishable from noise. Moreover, the peaks associated with an isotopologue are concentrated by a specific offset.

In some embodiments, the presence of one or more isopairs can be used to verify a data point as being associated with a signal representing a true metabolite signal. The probability of finding isopairs in a region of noise (e.g., false positives) relative to the number of true positives decreases as the number of samples' m/z signal intensities being merged increases. Various embodiments may set different thresholds for the number of samples' m/z-signal intensities to be merged based on different levels of probabilities deemed to be acceptable. Additionally, the false positive rate can be further controlled by requiring isopairs to occur more than once. For example, hundreds to thousands of samples' m/z-signal intensities may be merged into a single file that can be searched for isopairs by using data reduction techniques. Instead of looking within a single retention time scan across multiple samples when chromatography data is also merged, such a search may be applied across all retention windows in a single sample to detect enough signals to identify sets of isopairs in a highly sensitive fashion. Thus, the present approach to amplification and detection of compound signals represents an improvement over prior label-based detection not only in terms of feasibility, cost, and time efficiency, but is also an improvement in terms of sensitivity, robustness, scalability, more accurate, affordable, and applicable to untargeted compound analytics-all while avoiding the computational consequences of existing methods such as signal loss and high false positive rates.

In various embodiments, samples may be run and analyzed in a single batch (e.g., plate), while other embodiments may include multiple batches over time. Large datasets may be split into multiple batches of one or more samples where only a subset of samples may be prepped at a given time. The addition of more batches may introduce drift (e.g., related to thermal, kinetic, stochastic effects) between the associated batch data even with calibrations. Whatever amount of mass drift that exists from one sample's m/z signal intensities to that of another sample may be global to the data points within the respective sample, thereby affecting the m/z signal intensities for all ions. Thus, while the effect of concentrated signals (e.g., peaks) may appear in each data file/sample, the center of the compound peak in a first data file/sample may not exactly overlap the compound peak in a second data file/sample. Rather, the compound peaks may exhibit a certain amount of drift (e.g., −2 to 9 ppm or even more) between m/z signal intensities associated with different batches.

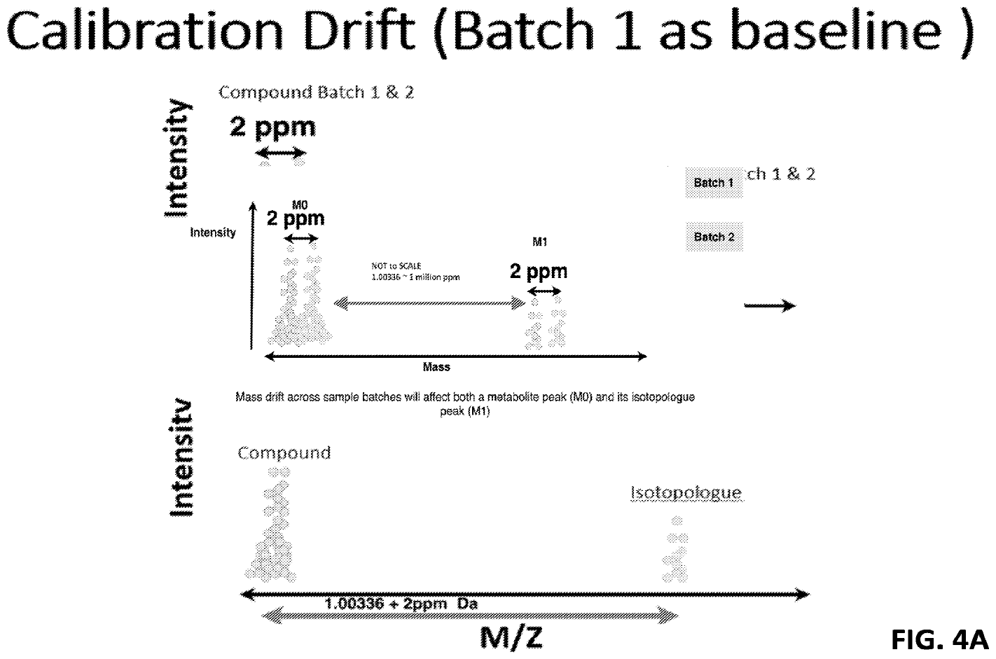

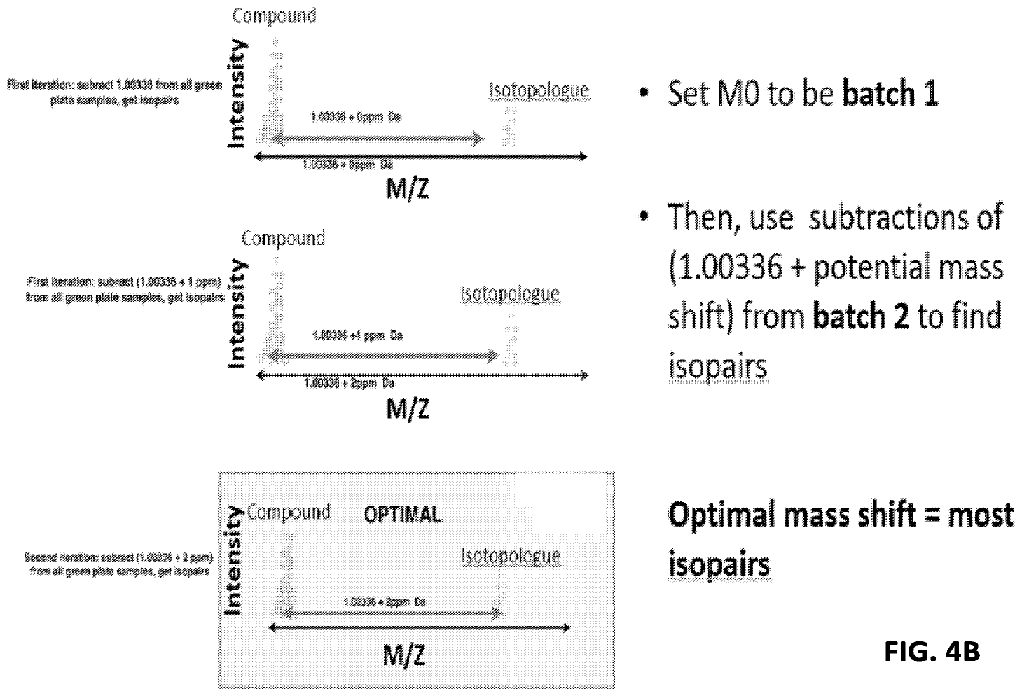

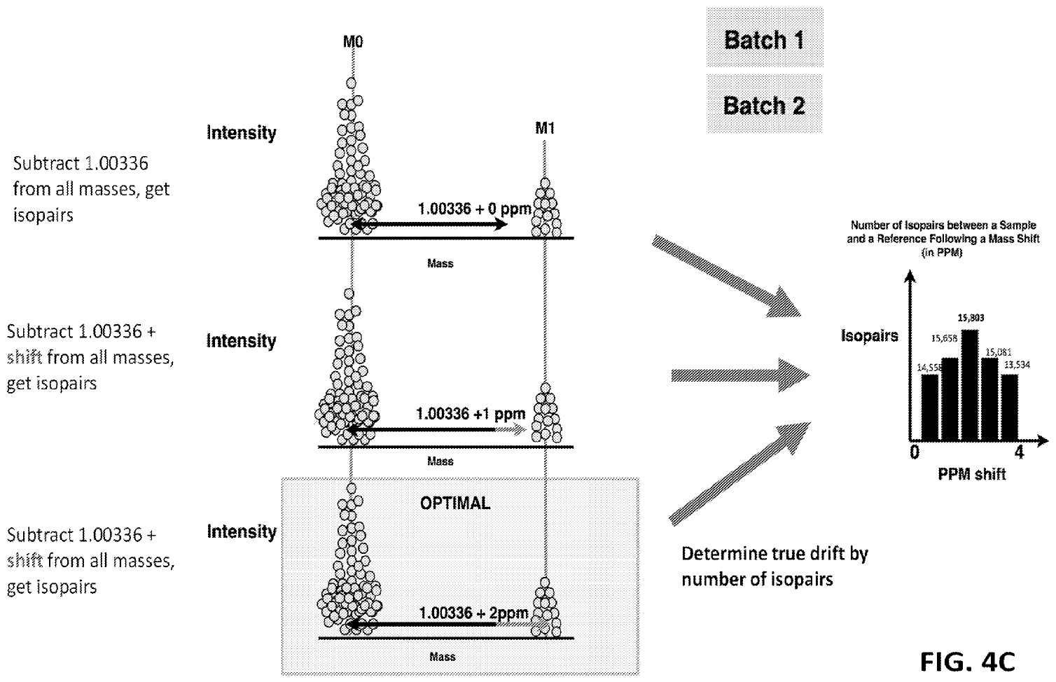

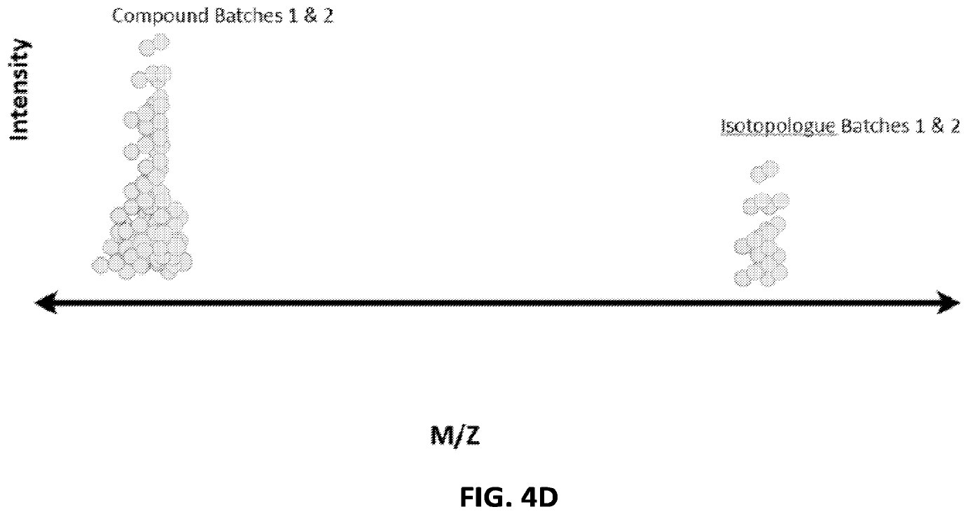

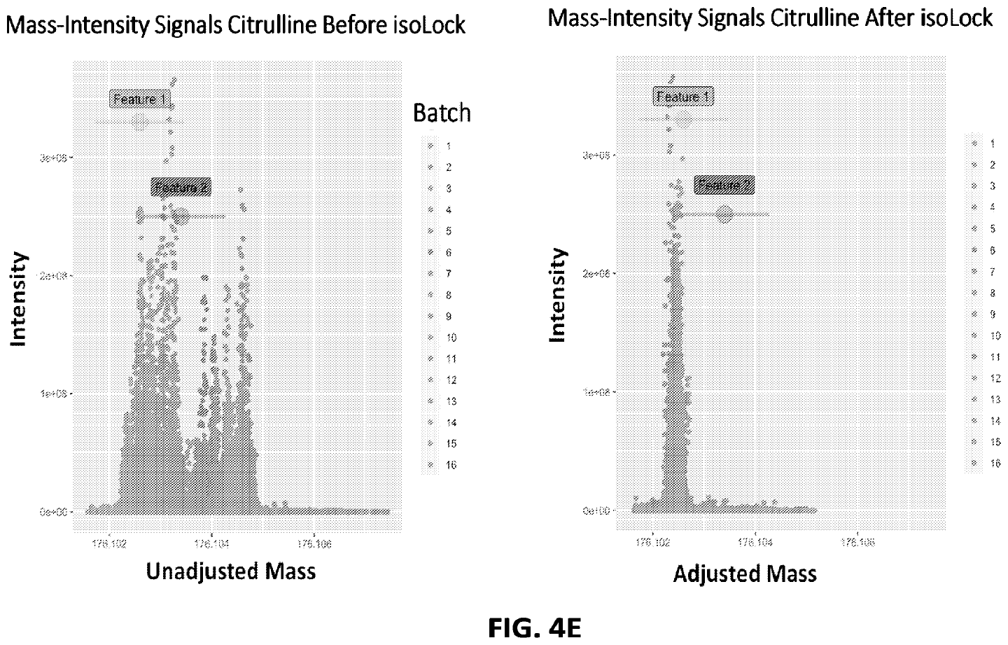

FIG. 4A illustrates an exemplary set of merged m/z signal intensities resulting from the combination of a plurality of files containing m/z signal intensities from individual samples within multiple sample batches where there is a 2 ppm mass shift between the two batches, which impacts the m/z signal intensity for both the compound and its isotopologue. As illustrated, the merged m/z signal intensities may be associated with multiple samples (e.g., from different batches). While a peak is present, such peak may be distributed over a wider range when drift is present.

Various embodiments of the present disclosure may include correcting for such drift between different batches. Such correction for drift may generate a merged file of mass-shifted m/z signal intensities by determining and then correcting for an identified mass shift between batches. This may create a merged file of m/z signal intensities such that m/z data from multiple batches are now aligned with one another in the files of merged m/z signal intensities. FIG. 4A depicts a realistic mass shift of 2 ppm between two different batches of samples.

FIG. 4B illustrates that different mass shifts that are less than the actual mass shift generate varying numbers of isopairs depending on the distance from the true mass shift, where a putative mass shift that is less than the actual mass shift may generate fewer isopairs than the true mass shift of 2 ppm and the true mass shift of 2 ppm may produce the most isopairs, and FIG. 4C illustrates that different mass shifts greater than the actual mass shift generate varying numbers of isopairs, depending on the distance from the true mass shift where a putative mass shift that is more than the actual mass shift may generate fewer isopairs than the true mass shift of 2 ppm and the true mass shift of 2 ppm may produce the most isopairs. FIGS. 4B and 4C show different mass shifts generate varying numbers of isopairs, with the highest number of isopairs being generated when all signals originating from batch 2 are shifted by 2 ppm relative to batch 1. Different amounts of mass shift may be used, however, based on a comparison of different potential mass shifts.

In embodiments of the present disclosure, the optimal mass shift may be defined as one resulting in the most isopairs. For example, where there are multiple batches, the distance of a compound peak from a first batch may be compared to the isotopologue peak from the second batch where the distance depends on both the mass of an elemental isotope plus a mass shift due to mass drift. Such mass shift can be determined by finding isopairs between the compounds in a reference batch and potential isotopologues in a query batch, while testing multiple potential mass shifts one at a time as shown in FIGS. 4A and 4B. As discussed herein, assuming no mass drift, the mass offset between a compound and its corresponding isotopologue is known as corresponding to the mass of the isotopic atom. Citrulline, for example, has a mass offset of 1.00336 from its carbon-13 isotopologue based on the additional mass of a carbon-13 atom. Thus, isopairs may be identified based on a combination of the mass offset plus a potential mass shift amount. Different potential mass shift amounts may be evaluated and compared to determine which may correspond to the most isopairs.

Whereas FIG. 4A depicts a realistic mass shift of 2 ppm between two different batches of samples, FIGS. 4B and 4C show that different mass shifts generate varying numbers of isopairs, with the highest number of isopairs being generated when all signals originating from batch 2 are shifted by 2 ppm relative to those in batch 1. The mass shift associated with the most isopairs may therefore be selected to use in generating the merged file of mass-shifted m/z signal intensities with the drift removed such that Gaussian-distributed signals around any true m/z signal intensity overlap one another regardless of batch. This is shown in FIG. 4D, which illustrates a merged spectra of m/z signal intensities in which the mass drift has been corrected via a shift of 2 ppm, thereby maximizing the ability to detect isopairs. Once the spectra of mass-shifted m/z signal intensities is generated, it can be used to identify isopairs that signify true metabolite signals. The illustration of FIG. 4D illustrates that correcting for mass drift creates a merged output of mass-intensity signals that have the most statistical power for detecting isopairs. FIG. 4E illustrates merged spectra of m/z signal intensities of citrulline before and after the mass drift of citrulline has been corrected via a shift of 2 ppm based on the true mass shift determined in FIG. 4D.

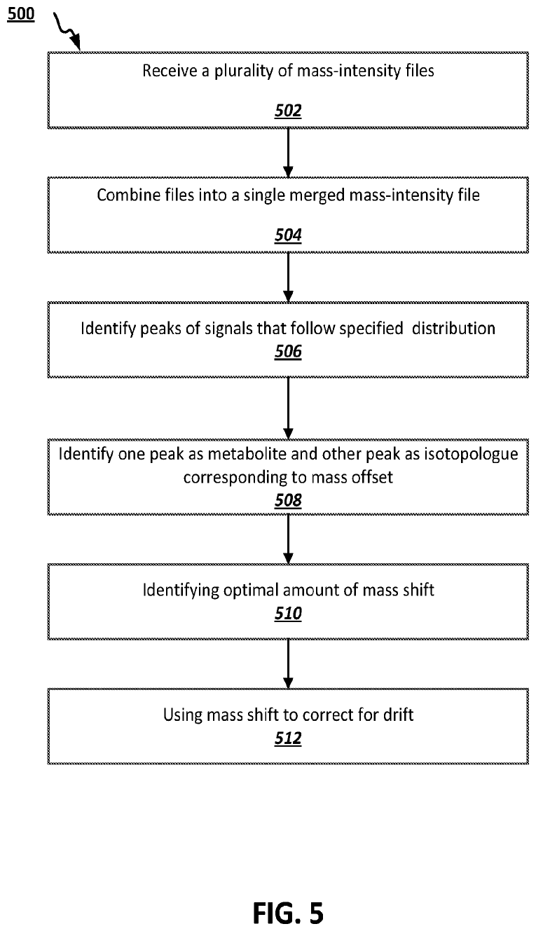

FIG. 5 is a flowchart illustrating an exemplary method 500 for amplification and detection of metabolite signals. In method 500, a plurality of files containing m/z signal intensities may be captured by a mass spectrometer. Chromatographic data for all signals may also be incorporated if the relevant equipment is used and such data is collected. Each file of m/z signal intensities may include signals associated with mass measurements of compounds in a respective sample. The datasets of the m/z signal intensities may be combined into a merged file of m/z signal intensities. A concentration of signals may be identified in the merged files of m/z signal intensities as following a specified statistical distribution and determined to be indicative of a metabolite when the concentration of signals corresponds to one or more mass measurements associated with a metabolite and an isotopologue of the metabolite. Because such a process of correcting for mass-drift incorporates isotopologues and effectively “locks” the Gaussian distributions for a single m/z intensity signal upon each other despite batch-related drifts, such process may be referred to herein as “isolock.”

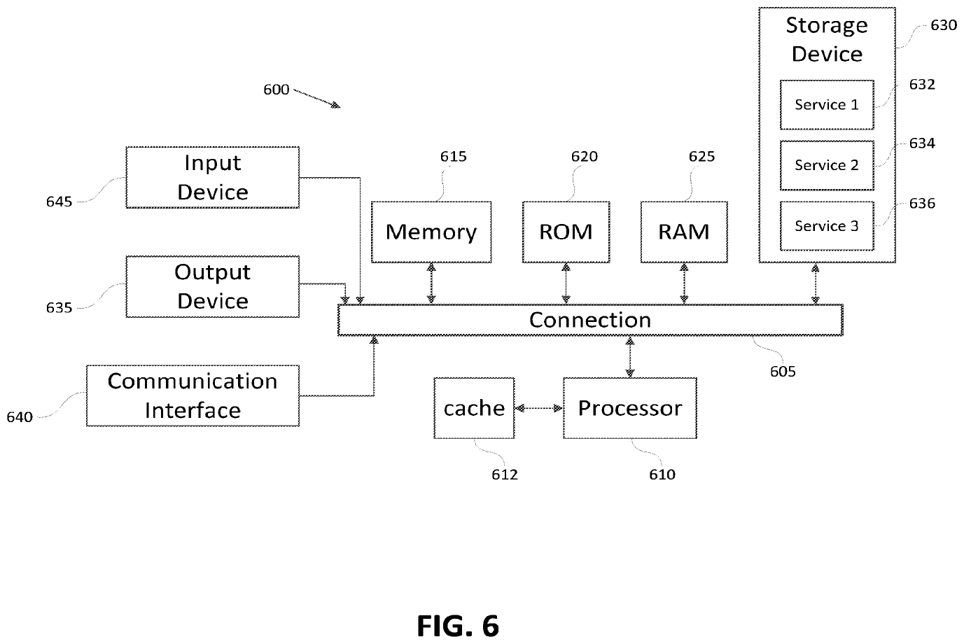

In step 502, a plurality of data sets may be received at a computing system (described in further detail in relation to FIG. 6). Such data sets may be communicated to the computing system using any of a variety of interfaces known in the art for communicating information (e.g., mass spectrometry datasets) captured by a mass spectrometer to the computing device for analysis. Each data set may correspond to m/z signal intensities that include signals associated with different mass measurements of compounds in a sample and may also contain the retention time or other chromatographic data information associated with each signal. In addition to chromatography, different separation techniques (e.g., electrophoresis, ion mobility, etc.) may also be used in conjunction with mass spectrometry to analyze isotopic patterns.

In step 504, a plurality of m/z signal-intensities may be combined into a file of merged m/z signal-intensities. As noted herein, increasing the number of samples' m/z signal intensities may result in increasing concentrations of compound signals about its associated mass measurements, as well as increasing concentrations of the associated isotopologue signals. Thus, signal patterns that may not be distinguishable from noise within a single sample's mass-intensity file may begin to emerge within a merged spectra of m/z signal intensities based on multiple samples' m/z signal intensities. For example, different peaks may become more prominent as more samples' m/z signal intensities are combined within the merged chromatogram.

In step 506, peaks may be identified within the merged m/z signal intensities. Such peaks may correspond to a specified distribution, such as a Gaussian distribution. In comparison to noise (which may be randomly distributed), signals that are indicative of a particular compound may tend to center around the mass measurement of that compound. Thus, peaks corresponding to a Gaussian distribution within the merged chromatogram may be a valid indicator of the compound.

In step 508, isopairs of the peaks may be identified within the merged m/z signal intensities. As discussed herein, isopairs (e.g., a specific compound and its corresponding isotopologue) may be associated with a specific offset based on the difference in isotopic mass. For example, carbon-13 isotopologues are associated with a mass offset of 1.00336 based on the isotopic mass difference of a carbon-13 atom. The identification that a first peak corresponds to a specific compound may be verified, therefore, based on the second peak corresponding to the isotopologue appearing at the mass offset within the merged m/z signal intensities.

Steps 510 and 512 may be performed in implementations that involve multiple batches (e.g., plates). In such implementations, drift may exist between the different batches, and as such, may require correction. In step 510, an amount of mass shift may be identified as the optimal amount to correct for drift. Different amounts of potential mass shifts may be evaluated and compared to which one corresponds to the most isopairs. In an exemplary embodiment, the amount of mass shift resulting in the most isopairs may be selected to correct for the drift.

In step 512, the selected amount of mass shift may be used to correct for mass drift. Such correction may include generating a merged file of mass-shifted spectra m/z signal intensities by introducing the selected amount of mass shift into an original spectra of m/z signal intensities. The mass-shifted spectra of m/z signal intensities may thereafter replace the original spectra of m/z signal intensities data such that isopairs may be used to identify compounds in the corrected spectra of m/z signal intensities.

FIG. 6 shows an example of computing system 600 in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments computing system 600 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read only memory (ROM) and random access memory (RAM) to processor 610. Computing system 600 can include a cache of high-speed memory connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement and therefore the basic features here may easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for amplification and detection of compound signals, the method comprising:
receiving a plurality of data files that include mass-to-charge (m/z) signal intensities captured by a mass spectrometer, wherein the m/z signal intensities correspond to signals associated with mass measurements of compounds in a sample;
combining the plurality of data files into a merged file that includes a merged spectra of m/z signal intensities;
identifying a concentration of signals within the merged spectra of m/z signal intensities of the merged file, the concentration of signals identified as following a specified statistical distribution; and
determining that the concentration of signals is indicative of a compound when the concentration of signals corresponds to one or more mass measurements associated with the compound and an isotopologue of the compound.

2. The method of claim 1, wherein determining that the concentration of signals within the merged m/z signal intensities is indicative of the compound includes verifying that the concentration of signals includes a first peak associated with the compound and a second peak associated with the isotopologue.

3. The method of claim 2, wherein the first peak is offset from the second peak based on a difference in mass between the compound and the isotopologue, and wherein verifying the concentration of signals includes initially identifying the first peak and subsequently identifying the second peak based on the offset.

4. The method of claim 1, further comprising identifying the type of the compound based on the mass measurements, wherein the type of the compound is identified as at least one of a specific metabolite or organic compound.

5. The method of claim 1, wherein the isotopologue includes a carbon-13 isotope of the compound, and wherein the concentration of signals includes a first peak associated with the compound that is offset from a second peak associated with the isotopologue, the offset corresponding to carbon-13 mass.

6. The method of claim 1, wherein the specified statistical distribution follows a Gaussian distribution.

7. The method of claim 1, further comprising correcting for drift among the plurality of data files based on a mass offset associated with the compound and the isotopologue.

8. The method of claim 7, wherein correcting for drift comprises:
generating a mass-shifted m/z signal intensities file by injecting a mass shift to each of the signals in the merged spectra of m/z signal intensities; and
updating the merged file of m/z signal intensities based on the generated mass-shifted m/z signal intensities file.

9. The method of claim 8, further comprising identifying an optimal amount of the mass shift based on the mass offset associated with the compound and the isotopologue.

10. The method of claim 9, wherein identifying the amount of mass shift comprises:
comparing a peak associated with the compound and a peak associated with the isotopologue in at least two samples;
identifying pairs of the compound and the isotopologue based on the mass offset, wherein each of the pairs is associated with an amount of mass shift; and
identifying the optimal amount of mass shift based on correspondence to a greatest number of pairs.

11. A system for amplification and detection of compound signals, the system comprising:
an interface that receives a plurality of data files that include mass-to-charge (m/z) signal intensities captured by a mass spectrometer, wherein the m/z signal intensities correspond to signals associated with mass measurements of compounds in a sample; and
a processor that executes instructions stored in memory, wherein the processor executes the instructions to:
combine the plurality of data files into a merged file that includes a merged spectra of m/z signal intensities;
identify a concentration of signals within the merged spectra of m/z signal intensities of the merged file, the concentration of signals identified as following a specified statistical distribution; and
determine that the concentration of signals is indicative of a compound when the concentration of signals corresponds to one or more mass measurements associated with the compound and an isotopologue of the compound.

12. The system of claim 11, wherein the processor determines that the concentration of signals within the merged m/z signal intensities is indicative of the compound by verifying that the concentration of signals includes a first peak associated with the compound and a second peak associated with the isotopologue.

13. The system of claim 12, wherein the first peak is offset from the second peak based on a difference in mass between the compound and the isotopologue, and wherein the processor verifies the concentration of signals by initially identifying the first peak and subsequently identifying the second peak based on the offset.

14. The system of claim 11, wherein the processor executes further instructions to identify the type of the compound based on the mass measurements, wherein the type of the compound is identified as at least one of a specific metabolite or organic compound.

15. The system of claim 11, wherein the isotopologue includes a carbon-13 isotope of the compound, and wherein the concentration of signals includes a first peak associated with the compound that is offset from a second peak associated with the isotopologue, the offset corresponding to carbon-13 mass.

16. The system of claim 11, wherein the specified statistical distribution follows a Gaussian distribution.

17. The system of claim 11, wherein the processor executes further instructions to correcting for drift among the plurality of data files based on a mass offset associated with the compound and the isotopologue.

18. The system of claim 17, wherein the processor corrects for drift by:
generating a mass-shifted m/z signal intensities file by injecting a mass shift to each of the signals in the merged spectra of m/z signal intensities; and
updating the merged file of m/z signal intensities based on the generated mass-shifted m/z signal intensities file.

19. The system of claim 18, wherein the processor executes further instructions to identify an optimal amount of the mass shift based on the mass offset associated with the compound and the isotopologue.

20. The system of claim 19, wherein the processor identifies the amount of mass shift by:
comparing a peak associated with the compound and a peak associated with the isotopologue in at least two samples;
identifying pairs of the compound and the isotopologue based on the mass offset, wherein each of the pairs is associated with an amount of mass shift; and
identifying the optimal amount of mass shift based on correspondence to a greatest number of pairs.

21. A non-transitory computer-readable storage medium having embodied thereon instructions executable by a processor to perform a method for amplification and detection of compound signals, the method comprising:
receiving a plurality of data files that include mass-to-charge (m/z) signal intensities captured by a mass spectrometer, wherein the m/z signal intensities correspond to signals associated with mass measurements of compounds in a sample;
combining the plurality of data files into a merged file that includes a merged spectra of m/z signal intensities;
identifying a concentration of signals within the merged spectra of m/z signal intensities of the merged file, the concentration of signals identified as following a specified statistical distribution; and
determining that the concentration of signals is indicative of a compound when the concentration of signals corresponds to one or more mass measurements associated with the compound and an isotopologue of the compound.

22. The non-transitory computer-readable storage medium of claim 21, wherein determining that the concentration of signals within the merged m/z signal intensities are indicative of the compound includes verifying that the concentration of signals includes a first peak associated with the compound and a second peak associated with the isotopologue.

23. The non-transitory computer-readable storage medium of claim 22, wherein the first peak is offset from the second peak based on a difference in mass between the compound and the isotopologue, and wherein verifying the concentration of signals includes initially identifying the first peak and subsequently identifying the second peak based on the offset.

24. The non-transitory computer-readable storage medium of claim 21, further comprising instructions executable to identify the type of the compound based on the mass measurements, wherein the type of the compound is identified as at least one of a specific metabolite or organic compound.

25. The non-transitory computer-readable storage medium of claim 21, wherein the isotopologue includes a carbon-13 isotope of the compound, and wherein the concentration of signals includes a first peak associated with the compound that is offset from a second peak associated with the isotopologue, the offset corresponding to carbon-13 mass.

26. The non-transitory computer-readable storage medium of claim 21, wherein the specified statistical distribution follows a Gaussian distribution.

27. The non-transitory computer-readable storage medium of claim 21, further comprising instructions executable to correct for drift among the plurality of data files based on a mass offset associated with the compound and the isotopologue.

28. The non-transitory computer-readable storage medium of claim 27, wherein correcting for drift comprises:
generating a mass-shifted m/z signal intensities file by injecting a mass shift to each of the signals in the merged spectra of m/z signal intensities;
updating the merged file of m/z signal intensities based on the generated mass-shifted m/z signal intensities file.

29. The non-transitory computer-readable storage medium of claim 28, further comprising instructions executable to identify an optimal amount of the mass shift based on the mass offset associated with the compound and the isotopologue.

30. The non-transitory computer-readable storage medium of claim 29, wherein identifying the amount of mass shift comprises:
comparing a peak associated with the compound and a peak associated with the isotopologue in at least two samples;
identifying pairs of the compound and the isotopologue based on the mass offset, wherein each of the pairs is associated with an amount of mass shift; and
identifying the optimal amount of mass shift based on correspondence to a greatest number of pairs.
